(19) United States
(12) Patent Application Publication
(10) Pub. No.: US 2006/0197583 A1
(43) Pub. Date: Sep. 7, 2006

(54) METHOD OF ENHANCING EFFICIENCY OF CHARGE PUMP CIRCUIT AND CHARGE PUMP SELECTOR CIRCUIT

(76) Inventors: Chih-Jen Yen, Hsinchu City (TW); Chih-Yuan Hsieh, Chiayi City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,134

(22) Filed: Jun. 10, 2005

(30) Foreign Application Priority Data
Mar. 3, 2005 (TW) 94106398

(51) Int. Cl. G05F 1/10

(52) U.S. Cl. 327/536

(57) ABSTRACT

A method for enhancing efficiency of charge pump circuit, and a charge pump control selector are provided. Power consumption of output, delivered from the charge pump unit to the load circuit, is detected. A sample signal is obtained and compared with a reference signal to generate a comparison signal. The comparison signal is converted to a control signal to provide feedback for tuning the input frequency of the charge pump unit. The detection of load is categorized in two detection modes, the voltage detection mode, and the current detection mode. The detection modes detect variations of ripple amplitudes of the output voltage of the charge pump circuit and variations of the load currents. The comparator converts the sample signal to a comparison signal. According to the comparison signal, the control method of the controller is determined. The controllers are categorized as continuous controller and discontinuous controller.

### CROSS-REFERENCE TO RELATED APPLICATION

This application claims the priority benefit of Taiwan application serial no. 94106398, filed on Mar. 3, 2005. All disclosure of the Taiwan application is incorporated herein by reference.

### BACKGROUND OF THE INVENTION

1. Field of the Invention

The present invention relates to a charge pump circuit, and more particularly to a method of enhancing efficiency in the charge pump circuit.

2. Description of the Related Art

A traditional charge pump circuit comprises a voltage source, a charging capacitor, a load capacitor, a plurality of circuit switches, and a frequency-fixed clock to control the circuit switches.

For a clock period, the voltage source and the charging capacitor are coupled in parallel through the circuit switch during the first half period so that the charging capacitor is charged to a voltage level. During the second half period, the voltage source and the charging capacitor are coupled in series through the circuit switch, and then coupled in parallel to the load capacitor. After several periods, the voltage drop between two ends on the load capacitor rises to a voltage level much higher than the original voltage source.

FIG. 1a is a drawing showing a traditional charge pump circuit. In the charge pump circuit, a clock with fixed input frequency is used. As shown in FIG. 1b, when the clock ψ1 of the input frequency turns on the circuit switches SW1 and SW4, the voltage source Vi charges the capacitor C1 to the level of the voltage source Vi. If the charge stored in the capacitor C2 is zero, and the clock ψ2 of the input frequency turns on the circuit switches SW2 and SW3, the charge stored in the capacitors C1 and C2 coupled in parallel are redistributed. After several periods of such redistribution, the voltage drop between two ends on the capacitor C2 can be raised to double the value of the voltage source, i.e., 2Vi, or n times of Vi.

According to the desired voltage level, the charge pump circuit with different stages can be used to charge the capacitors to the desired voltage. Since the load circuit consumes the charges stored in the load capacitor, the voltage drop on the load capacitor decreases with the loss caused by the load. In order to maintain the voltage of the load capacitor, after the load capacitor reaches the target voltage, the charge pump circuit must charge the load capacitor with a fixed frequency through the circuit switches. Accordingly, the capacitor C1 should receive charges from the voltage source Vi with a constant time period, and charges should be supplied to the capacitor C2 to maintain the voltage of the capacitor C2. Under this mechanism, the ripple effect occurs at the output voltage level of the charge pump circuit, when it has the same input frequency. The value of the ripple is inversely proportional to the value of the load capacitance, proportional to the power consumption of the load, and inversely proportional to the input frequency of the charge pump circuit.

FIG. 2 is a drawing showing a relationship between a clock of an input frequency and an amplitude of a ripple. Referring to FIG. 2, the ripple effect of the output voltage occurs when discharging at the clock ψ1 of the input frequency, and charging at the clock ψ2 of the input frequency. The amplitude of the ripple depends on the charging frequency of the charge pump circuit and the load current. For a fixed load current and the same charge pump circuit, the input frequency f1 is smaller than the input frequency f2. Accordingly, the discharging time of the first circuit 210 is longer than that of the second circuit 220. The amplitude of the ripple Vripple1 of the first circuit 210 also is larger than that of the ripple Vripple2 of the second circuit 220. Accordingly, a larger the load current would require higher frequency. However, it also increases the power consumption of the charge pump circuit. If the load current is increased, and the input frequency is fixed, the ripple effect becomes more serious due to the increasing load current. For circuit designers, choosing to reduce either the power consumption or noises becomes a dilemma.

A larger load capacitance would require more the stored charges. Under the same load power consumption and input frequency, the charge pump circuit with larger load capacitance has smaller ripple effect. This approach, however, increases the circuit area, and the load of the voltage source Vi.

### SUMMARY OF THE INVENTION

Accordingly, the present invention is directed to a method and apparatus for enhancing efficiency of a charge pump unit capable of substantially preventing one or more technical restrictions or issues in the conventional technology.

The present invention provides a method of enhancing efficiency of a charge pump circuit. According to the method, a sampling signal is obtained according to a power consumption of an output, which is delivered from a charge pump unit to a load circuit. The sampling signal and a reference signal are compared to obtain a comparison signal. The comparison signal is converted to a control signal to provide feedback for dynamically controlling the input frequency of the charge pump unit to enhance its efficiency.

According to the method of enhancing efficiency of a charge pump circuit of an embodiment of the present invention, the sampling signal is a voltage signal.

According to the method of enhancing efficiency of a charge pump circuit of an embodiment of the present invention, the sampling signal is a current signal.

According to the method of enhancing efficiency of a charge pump circuit of an embodiment of the present invention, the sampling signal is a voltage signal and a current signal.

According to the method of enhancing efficiency of a charge pump circuit of an embodiment of the present invention, the comparison signal is a plurality of codable level signals.

According to the method of enhancing efficiency of a charge pump circuit of an embodiment of the present invention, the comparison signal is a level signal.

According to the method of enhancing efficiency of a charge pump circuit of an embodiment of the present invention, the control signal generated from the codable level signals provides feedback for the tuning of the charge pump unit to enhance its efficiency in a continuous method.

According to the method of enhancing efficiency of a charge pump circuit of an embodiment of the present invention, the continuous method is by feedback tuning an input frequency in real-time.

According to the method of enhancing efficiency of a charge pump circuit of an embodiment of the present invention, the control signal generated from the level signal provides feedback for the tuning of the charge pump unit to enhance its efficiency in a discontinuous method.

According to the method of enhancing efficiency of a charge pump circuit of an embodiment of the present invention, the discontinuous method is a state-switching-feedback-tuning method.

According to the method of enhancing efficiency of a charge pump circuit of an embodiment of the present invention, both the continuous method and the discontinuous method are used to constitute a mix-type method of feedback tuning the charge pump unit to enhance its efficiency.

According to the method of enhancing efficiency of a charge pump circuit of an embodiment of the present invention, the mix-type method comprises: first performing the state-switching-feedback tuning method, i.e., the discontinuous method; if a state switch is off, no feedback tuning being performed; if the state switch is on, a feedback tuning being performed by feedback tuning the input frequency in real-time, i.e., the continuous method.

The present invention also provides a charge pump control selector circuit, which is adapted for a charge pump circuit. The charge pump control selector circuit comprises: a load detection circuit, a comparator circuit, and a controller circuit. The load detection circuit detects a ripple during an output from a charge pump unit to a load circuit to obtain a sampling signal according thereto. The comparator circuit receives the sampling signal, and compares the sampling signal with a reference signal to obtain a comparison signal. The controller circuit receives and transforms the comparison signal to a control signal to provide feedback for tuning the input frequency of the charge pump unit to enhance its efficiency.

According to the charge pump control selector circuit of an embodiment of the present invention, the sample signal obtained by the load circuit is a voltage signal.

According to the charge pump control selector circuit of an embodiment of the present invention, the sample signal obtained by the load circuit is a current signal.

According to the charge pump control selector circuit of an embodiment of the present invention, the sample signal obtained by the load circuit is a voltage signal and a current signal.

According to the charge pump control selector circuit of an embodiment of the present invention, the load detection circuit obtains the current signal by using a current mirror to sample the load current of the load circuit, and the current signal is converted to a voltage signal through a current/voltage converter.

According to the charge pump control selector circuit of an embodiment of the present invention, the comparator circuit comprises a plurality of comparator units.

According to the charge pump control selector circuit of an embodiment of the present invention, the comparator circuit comprises a single comparator unit.

According to the charge pump control selector circuit of an embodiment of the present invention, the comparator circuit is coupled to a continuous controller to provide feedback for tuning the input frequency of the charge pump unit to enhance its efficiency.

According to the charge pump control selector circuit of an embodiment of the present invention, the continuous controller operates by feedback tuning an input frequency in real-time.

According to the charge pump control selector circuit of an embodiment of the present invention, the comparator circuit is coupled to a discontinuous controller to provide feedback for tuning the input frequency of the charge pump unit to enhance its efficiency.

According to the charge pump control selector circuit of an embodiment of the present invention, the discontinuous controller operates in a state-switching-feedback-tuning method.

According to the charge pump control selector circuit of an embodiment of the present invention, both the continuous controller and the discontinuous controller are used in the same circuit to form a mix-type controller to provide feedback for tuning the input frequency of the charge pump unit to enhance its efficiency.

According to the charge pump control selector circuit of an embodiment of the present invention, the mix-type controller comprises: the discontinuous controller, and the continuous controller. The discontinuous controller first performs the state-switching-feedback-tuning method. If a state switch is off, no feedback tuning is performed; if the state switch is on, feedback tuning is performed as the continuous controller provides feedback for tuning the input frequency in real-time.

The present invention also provides a charge pump circuit. The circuit comprises the charge pump control selector circuit described above.

The above and other features of the present invention will be better understood from the following detailed description of the preferred embodiments of the invention that is provided in communication with the accompanying drawings.

### BRIEF DESCRIPTION OF THE DRAWINGS

FIG. 1a is a drawing showing a traditional charge pump circuit.

FIG. 1b is a drawing showing operations of a plurality of circuit switches and capacitors C1 and C2, when the input frequency clocks are ψ1 and ψ2.

FIG. 2 is a drawing showing a relationship between a clock of an input frequency and an amplitude of a ripple.

FIG. 3 is a schematic drawing showing a charge pump circuit with a control selector circuit according to an embodiment of the present invention.

FIG. 4 is a detailed block diagram showing a control selector circuit according an embodiment of the present invention.

FIG. 5 is a schematic drawing showing a load detection circuit with the current-and-voltage detection mode according to an embodiment of the present invention.

FIG. 6 is a schematic drawing showing a load detection circuit with a current detection mode according to an embodiment of the present invention.

FIG. 7 is a schematic drawing showing a charge pump circuit with a continuous controller and the detection circuit in a voltage detection mode according to an embodiment of the present invention.

FIG. 8a is a schematic drawing showing a charge pump circuit with a discontinuous control circuit and a detection circuit in a voltage detection mode according to an embodiment of the present invention.

FIG. 8b is a drawing showing an operational mechanism of blocks A and B of FIG. 8a.

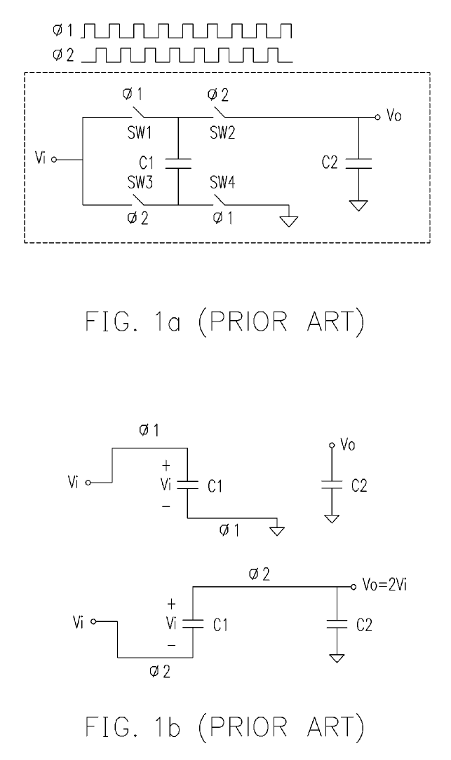

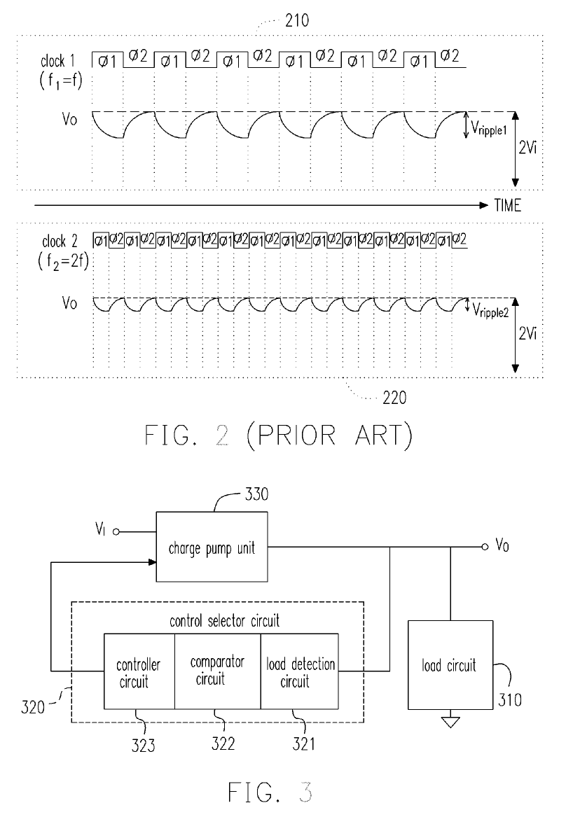

### DESCRIPTION OF SOME EMBODIMENTS

The preferred features of the selected embodiments of the present invention are described with figures. The present invention, however, is not limited thereto. Note that dimensions of the structures in these figures are not specified. The structures and materials can be properly modified without departing from the scope of the present invention.

If the load current of the charge pump load circuit varies with time, the desired input frequency and capacitance are selected according to the maximum load to satisfy the minimum requirement of the ripple. Under the circuit design of the charge pump circuit with fixed input frequency, if the desired load is low, and the input frequency is a fixed high input frequency, the power would be wasted and the efficiency of the charge pump circuit would be reduced. If the desired load is designed higher than the original value, and the input frequency is a fixed low input frequency, the amplitude of the ripple would be higher and noises would be generated. If a high-capacitance capacitor is used, the circuit area is increased and the load of the voltage source also is increased.

In order to overcome the issues described above, a charge pump control selector with a frequency-selection function is adopted. Wherein, the detection of the control selector to the load is categorized into two modes, the voltage mode and the current mode. These two detection modes are by detecting the variations of the ripple amplitudes of the output voltage of the charge pump circuit and the variations of the load currents, respectively. The sample signal is then converted to a comparison signal through a comparator. According to the comparison signal, the control method of the controller is determined. Wherein, the controller is categorized as a continuous controller and a discontinuous controller according to variations of the load circuit.

In the embodiment of using the continuous controller, if the charge pump circuit outputs a small voltage ripple or a small load current, the control selector circuit selects the low input frequency to save the power consumption so as to enhance the efficiency of the charge pump circuit during the switching of the charge pump circuit. If the charge pump circuit outputs a large voltage ripple or a large load current, the control selector circuit selects the high input frequency to reduce the ripple effect of the output voltage of the charge pump circuit.

The discontinuous controller is adapted for the load with fewer variations. If the ripple of the output voltage of the charge pump circuit is small, the controller operates under the power-saving mode, and the switch of the charge pump circuit does not function until the value of the ripple is larger than a specific value. The controller then controls the switching of the charge pump circuit.

FIG. 3 is a schematic drawing showing a charge pump circuit with a control selector circuit according to an embodiment of the present invention. Referring to FIG. 3, the charge pump circuit comprises a load circuit 310, a control selector circuit 320, and a charge pump unit 330. The control selector circuit dynamically controls the switching of the charge pump unit 330 according to the different load currents and voltages of the load circuit 310 to satisfy the requirement of the maximum ripple. Accordingly, the power of the charge pump unit 330 can be used more efficiently. Wherein, the control selector circuit 320 comprises three parts, the load detection circuit 321, the comparison circuit 322, and the controller circuit 323.

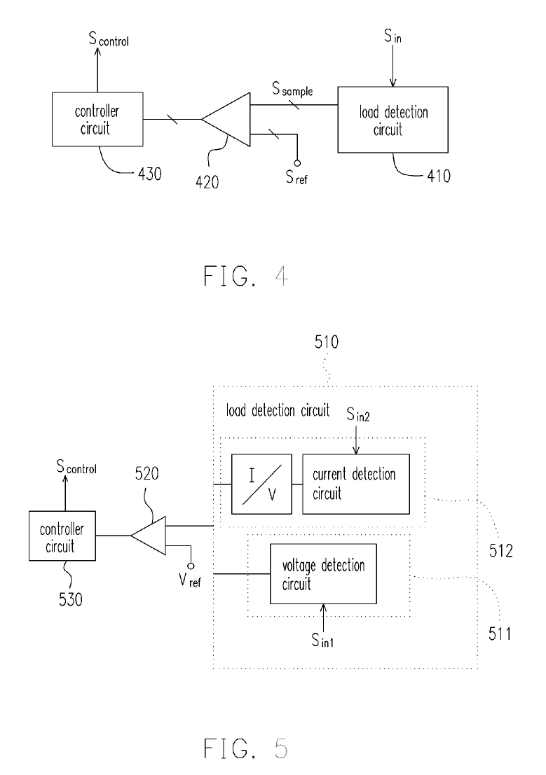

FIG. 4 is a detailed block diagram showing a control selector circuit according an embodiment of the present invention. The control selector circuit comprises a load detection circuit 410, a comparison circuit 420, and a controller circuit 430. After the load detection circuit 410 detects and samples a detection signal Sin from the load circuit, the sample signal Ssample is input to the comparison circuit 420. The comparison circuit 420 compares the sample signal Ssample and the reference signal Sref so that the next-stage controller circuit 430 outputs the control signal Scontrol to control the switching of the charge pump circuit.

The mode of the detection circuit of the charge pump circuit is categorized as three modes, the voltage detection mode, the current detection mode, and the voltage-and-current detection mode. FIG. 5 is a schematic drawing showing a load detection circuit with the current-and-voltage detection mode according to an embodiment of the present invention. Referring to FIG. 5, the load detection circuit with the current-and-voltage detection mode comprises a load detection circuit 510, a comparison circuit 520, and a controller circuit 530. The load detection circuit 510 comprises a voltage detection circuit 511 and a current detection circuit 512. The voltage detection circuit 511 of the load detection circuit 510 samples a voltage detection signal Sin1 so as to analyze the value of the ripple of the output voltage of the charge pump circuit. The current detection circuit 512 of the load detection circuit 510 samples a current detection signal Sin2 so as to analyze the value of the load current of the load circuit. After received and processed, the current detection signal Sin2 is through a current-voltage conversion, and is output to a comparison circuit 520. Then the control signal Scontrol is output from the controller circuit 530 to control the switching of the charge pump unit.

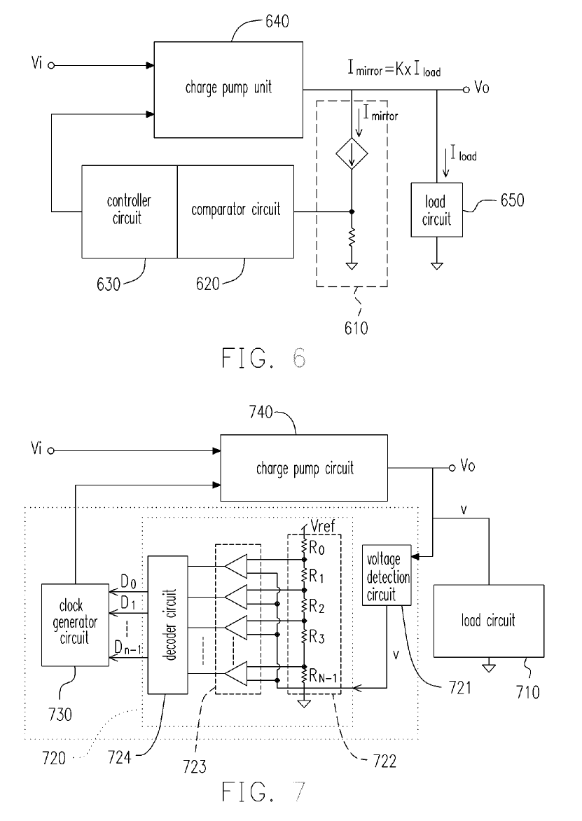

FIG. 6 is a schematic drawing showing a load detection circuit with a current detection mode according to an embodiment of the present invention. The charge pump circuit comprises a current mirror circuit 610, a comparison circuit 620, a controller circuit 630, and a charge pump unit 640. The load detection circuit with the current detection mode operates with the current mirror to replicate the load current Iload of the load circuit 650 into the mirror current Imirror through the current mirror circuit 610, wherein the mirror current Imirror=KxIload, and K is a constant. The mirror current Imirror is converted to a voltage signal, which is input to the comparison circuit 620 for comparison. The comparison result is input to the controller circuit 630. According to the comparison result from the comparison circuit 620, the controller circuit 630 generates the control signal of the charge pump unit 640.

Generally, the controllers are categorized as the continuous controller circuit and the discontinuous controller circuit. These two circuits can be used separately or together. The discontinuous controller circuit can be separately used, the continuous controller circuit can be separately used, and the mix-type controller circuit can be used.

If the continuous controller circuit is separately used, its operation depends on the input frequency of the charge pump circuit. The input frequency includes several different frequencies according to the requirements of the loads. By detecting the variations of the load, the input frequencies corresponding thereto are selected to optimize the charge pump circuit corresponding to the value of the ripple.

If the discontinuous controller circuit is separately used, its operation depends on the output voltage of the charge pump circuit. If the output voltage is higher than a reference value, the controller circuit is controlled under a stable state so the switch of the charge pump circuit does not operate. If the output voltage is lower than the reference value, the controller is controlled under a bi-stable state, and the charge pump circuit is turned on to charge the load capacitor.

For the mix-type controller circuit, its operation depends on the output voltage of the charge pump circuit. If the output voltage is higher than a reference value, the controller is turned off. If the output voltage is lower than a reference value, its operation is similar to the method in which the continuous controller circuit is separately used.

FIG. 7 is a schematic drawing showing a charge pump circuit with a frequency-selection function according to an embodiment of the present invention. In this embodiment, the detection circuit is the continuous controller circuit with the voltage detection mode. The charge pump circuit comprises a load circuit 710, a control selector circuit 720, a clock generator circuit 730, and a charge pump unit 740. The control selector circuit 720 has a frequency-selection function. It comprises a voltage detection circuit 721, a voltage-dividing circuit 722, a comparison circuit 723, and a decoder circuit 724. The voltage detection circuit 721 samples the output voltage from the charge pump unit 740, and inputs the sample signal to the comparison circuit 723. The sample signal is then compared with several reference voltages generated from the voltage-dividing circuit 722. The decoder circuit 724 generates decoded signals D0-Dn-1 to trigger the clock generator circuit 730 to generate the desired input frequencies of the charge pump unit 740.

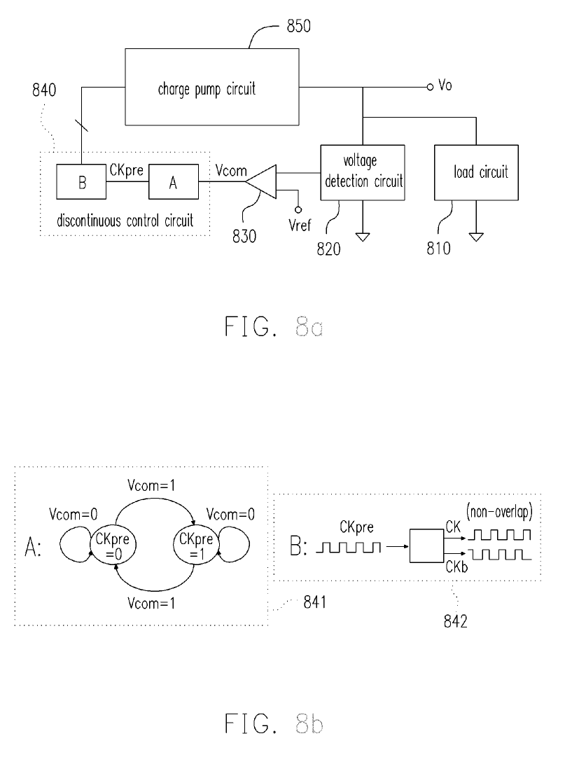

FIG. 8a is a schematic drawing showing a charge pump circuit of a discontinuous control circuit and a detection circuit with a voltage detection mode according to an embodiment of the present invention. The charge pump circuit comprises a load circuit 810, a voltage detection circuit 820, a comparison circuit 830, a discontinuous control circuit 840, and a charge pump unit 850. The discontinuous control circuit 840 comprises two blocks A and B. As shown in FIG. 8b, if the input state signal Vcom is 0, the block A 841 enters the stable state, i.e., one of the two states shown in the diagram of the block A 841. A pair of stable control signals are then generated from the block B 842. If the input state signal Vcom is 1, the block A 841 enters into the bi-stable state, i.e., the situation under which the two states are continuously and alternatively switched to generate a continuously changing clock signal CKpre. After the block B 842, a non-overlapping control signal is generated to control the switching of the charge pump circuit.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A method of enhancing efficiency of a charge pump circuit, comprising:
obtaining a sampling signal according to a power consumption of an output, which is delivered from a charge pump unit to a load circuit;
comparing the sampling signal and a reference signal to obtain a comparison signal; and
transforming the comparison signal to a control signal to provide feedback for tuning the charge pump unit to enhance its efficiency.

2. The method of enhancing efficiency of a charge pump circuit of claim 1, wherein the sampling signal is a voltage signal and a current signal, or at least one of the above.

3. The method of enhancing efficiency of a charge pump circuit of claim 1, wherein the comparison signal is a plurality of codable level signals and a level signal, or at least one of the above.

4. The method of enhancing efficiency of a charge pump circuit of claim 3, wherein the control signal generated from the codable level signals provides feedback for tuning the charge pump unit to enhance its efficiency by using a continuous method.

5. The method of enhancing efficiency of a charge pump circuit of claim 4, wherein the continuous method is by feedback tuning an input frequency in real-time.

6. The method of enhancing efficiency of a charge pump circuit of claim 3, wherein the control signal generated from the level signal provides feedback for tuning the input frequency of the charge pump unit to enhance its efficiency by using a discontinuous method.

7. The method of enhancing efficiency of a charge pump circuit of claim 6, wherein the discontinuous method is a state-switching-feedback-tuning method.

8. The method of enhancing efficiency of a charge pump circuit of claim 4, wherein both the continuous method and the discontinuous method are used to constitute a mix-type method of feedback tuning the input frequency of the charge pump unit to enhance its efficiency.

9. The method of enhancing efficiency of a charge pump circuit of claim 6, wherein both the continuous method and the discontinuous method are used to constitute a mix-type method of feedback tuning the input frequency of the charge pump unit to enhance its efficiency.

10. The method of enhancing efficiency of a charge pump circuit of claim 8, wherein the mix-type method comprises:
first performing the state-switching-feedback tuning method;
if a state switch is off, no feedback tuning being performed; and
if the state switch is on, feedback tuning being performed by providing feedback for tuning the input frequency in real-time.

11. The method of enhancing efficiency of a charge pump circuit of claim 9, wherein the mix-type method comprises:
first performing the state-switching-feedback tuning method;
if a state switch is off, no feedback tuning being performed; and
if the state switch is on, feedback tuning being performed by providing feedback for tuning the input frequency in real-time.

12. A charge pump control selector circuit, adapted for a charge pump circuit, the charge pump control selector circuit comprising:
a load detection circuit, detecting a power consumption of an output, which is delivered from a charge pump unit to a load circuit, to accordingly obtain a sampling signal;
a comparator circuit, receiving the sampling signal, and comparing the sampling signal with a reference signal to obtain a comparison signal; and
a controller circuit, receiving and transforming the comparison signal to a control signal to provide feedback for tuning the input frequency of the charge pump unit to enhance its efficiency.

13. The charge pump control selector circuit of claim 12, wherein the sample signal obtained by the load circuit is a voltage signal and a current signal, or at least one of the above.

14. The charge pump control selector circuit of claim 13, wherein the load detection circuit obtains the current signal by using a current mirror to replicate a load current of the load circuit, and the current signal is converted to a voltage signal through a current/voltage converter.

15. The charge pump control selector circuit of claim 12, wherein the comparator circuit comprises a plurality of comparator units and a single comparator unit, or at least one of the above.

16. The charge pump control selector circuit of claim 15, wherein the comparator circuit constituted by the comparator units is coupled to a continuous controller to provide feedback for tuning the input frequency of the charge pump unit to enhance its efficiency.

17. The charge pump control selector circuit of claim 16, wherein the continuous controller operates by providing feedback for tuning an input frequency in real-time.

18. The charge pump control selector circuit of claim 15, wherein the comparator circuit constituted by the single comparator unit is coupled to a discontinuous controller to provide feedback for tuning the input frequency of the charge pump unit to enhance its efficiency.

19. The charge pump control selector circuit of claim 18, wherein the discontinuous controller operates in a state-switching-feedback-tuning method.

20. The charge pump control selector circuit of claim 16, wherein both of the continuous controller and the discontinuous controller are used in the same circuit to form a mix-type controller to provide feedback for tuning the input frequency of the charge pump unit to enhance its efficiency.

21. The charge pump control selector circuit of claim 18, wherein both of the continuous controller and the discontinuous controller are used in the same circuit to form a mix-type controller to provide feedback for tuning the input frequency of the charge pump unit to enhance its efficiency.

22. The charge pump control selector circuit of claim 20, wherein the mix-type controller comprises:
the discontinuous controller, performing the state-switching-feedback-tuning method first; and
if a state switch is off, no feedback tuning being performed; and
if the state switch is on, feedback tuning being performed in which the continuous controller provides feedback for tuning the input frequency in real-time.

23. The charge pump control selector circuit of claim 21, wherein the mix-type controller comprises:
the discontinuous controller, performing the state-switching-feedback-tuning method first; and
if a state switch is off, no feedback tuning being performed; and
if the state switch is on, feedback tuning being performed in which the continuous controller provides feedback for tuning the input frequency in real-time.
